(19) United States
(12) Patent Application Publication
(10) Pub. No.: US 2008/0084695 A1
(43) Pub. Date: Apr. 10, 2008

(54) Light string with extension light string

(76) Inventor: Fu-Hsien Hsu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/542,116

(22) Filed: Oct. 4, 2006

(51) Int. Cl. F21V 21/00

(52) U.S. Cl. 362/249; 362/391

(57) ABSTRACT

A light string includes a main light string and at least one extension light string. The main light string includes an AC power plug for connecting to an AC power supply, a light string wire circuit connected to the AC power plug, and a plurality of bulb holders connected to the light string wire circuit in series, so that a divided AC voltage of the AC power supply is allocated to each of the bulb holders, and a light emitting element may be mounted in the bulb holder to emit light. The extension light string includes a connector for connecting to any empty one of the bulb holders on the main light string, an AC/DC converting unit connected to the connector, and a plurality of extension bulb holders parallelly connected to DC voltage outputs of the AC/DC converting unit and having a light emitting element mounted therein.

### FIELD OF THE INVENTION

The present invention relates to a light string, and more particularly to a light string with extension light string, in which light emitting elements mounted in bulb holders on the extension light string may emit light when the extension light string is connected to any empty bulb holder on the main light string.

### BACKGROUND OF THE INVENTION

A general decorating light string includes a main wire, to which multiple bulb holders are connected. Each of the bulb holders has a bulb mounted therein. The light string is then connected to a power supply to drive the bulbs to emit light. Most light string manufacturers would usually made some different designs for the bulbs or the main wire, so that the bulbs not only emit visible light but also produce decorating effect.

Taiwanese New Utility Model Patent No. 00590188 discloses a belt light string consisting of light-emitting diodes (LEDs). The belt light string includes a plurality of light emitting units connected to one another. Each of the light emitting units includes a base formed of a recess, a circuit board received in the recess, a light-emitting diode mounted on the circuit board to serve as a light source, and a cover for closing the recess. The cover is provided at a position opposite to the light-emitting diode with an opening, so that light emitted by the light-emitting diode is projected through the opening.

Taiwanese New Utility Model No. 00318603 discloses a bulb for a decorative light string. The bulb is internally provided with two oppositely arranged copper filaments, and a plurality of tungsten filaments separately fastened to predetermined positions on the two copper filaments, such that a plurality of light spots are formed when the bulb is connected to a power supply.

However, even with the different designs for the bulbs or the light string wire, the whole light string still has a somewhat monotonous appearance without decorating effect to highlight the light string. Moreover, most of the currently available light strings have a fixed structure that restricts the light strings to be used with only alternating current (AC) or direct current (DC). Therefore, it is desirable to develop a light string that has not only decorating but also many other functions.

### SUMMARY OF THE INVENTION

A primary object of the present invention is to provide an extension light string that could be connected to a main light string via a connector. The extension light string includes an AC/DC converting unit connected to the connector, a plurality of extension bulb holders parallelly connected to the AC/DC converting unit, and a plurality of light emitting elements separately mounted in the extension bulb holders. The AC/DC converting unit converts an AC power supply input from the main light string into a DC power, which is sent to the extension bulb holders to drive the light emitting element to emit light.

In the present invention, the extension light string is connected to the main light string to provide a complete light string, and the extension light string includes an AC/DC converting unit to convert the AC power supply into a DC power. Therefore, the light emitting elements on the light string of the present invention can be driven to emit light not only by AC power but also DC power, allowing a user to use light emitting elements of different electric properties on the same one light string to achieve the purpose of decorating, and enabling the light string to have more functions.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic plan view of a light string with extension light string according to the present invention;

FIG. 2 is a circuit diagram of an extension light string for the light string of the present invention; and

FIG. 3 is an exploded sectional view showing a bulb holder and a light emitting element included in the extension light string of the present invention.

### DETAILED DESCRIPTION OF THE PREFERRED EMBODIMENTS

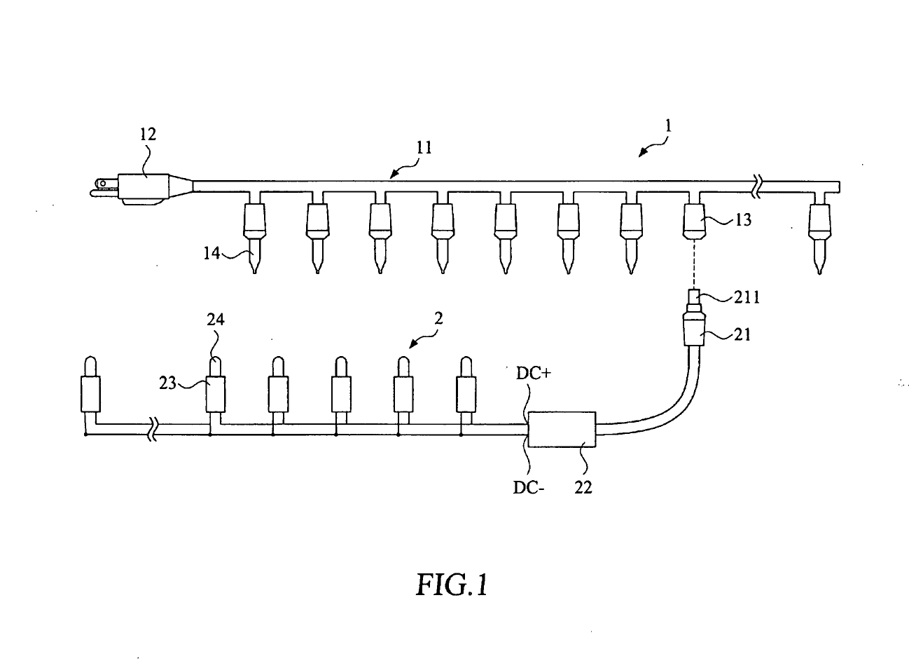

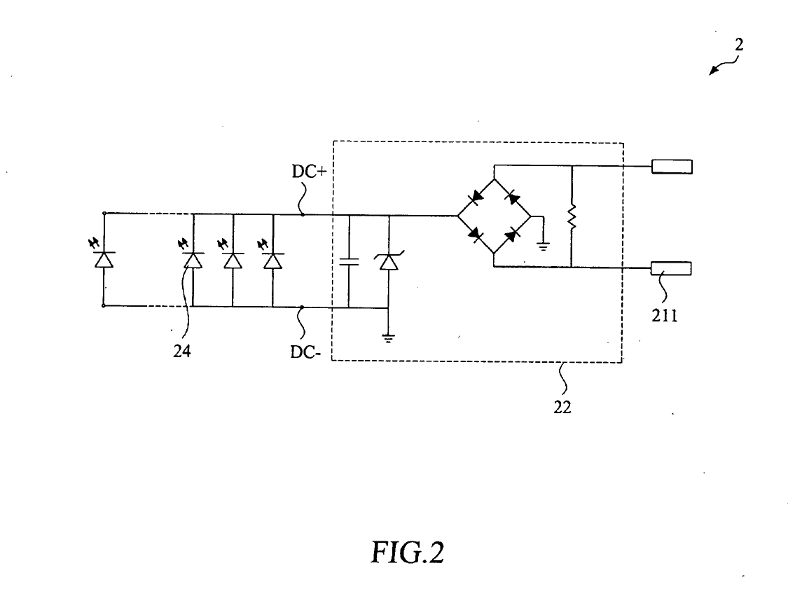

Please refer to FIG. 1 that is a schematic plan view of a light string with extension light string according to the present invention, and to FIG. 2 that is a circuit diagram of an extension light string for the light string of the present invention. As shown, the light string of the present invention includes a main light string 1 and at least one extension light string 2.

The main light string 1 includes a light string wire circuit 11, an AC power plug 12, and a plurality of bulb holders 13. The light string wire circuit 11 is connected to the AC power plug 12 and the bulb holders 13. The AC power plug 12 may be plugged in a receptacle connected to an AC power supply, so that AC power may be supplied to the AC power plug 12. The bulb holders 13 are electrically connected to the light string wire circuit 11 in series, such that a divided AC voltage of the AC power is allocated to each of the bulb holders 13. Moreover, each of the bulb holders 13 may have a light emitting element 14 mounted therein, such that the light emitting element 14 is driven by the allocated divided AC voltage to emit visible light.

The extension light string 2 includes a connector 21, an AC/DC converting unit 22, and a plurality of extension bulb holder 23. The connector 21 may be plugged in any empty one of the bulb holders 13 of the main light string 1 that does not have a light emitting element 14 mounted therein. The connector 21 is provided with a pair of conductive members 211 for leading out the divided AC voltage allocated to that bulb holder 13. The AC/DC converting unit 22 is connected to the connector 21 for converting the divided AC voltage led to the connector 21 of the extension light string 2 into a DC voltage, which is then output from a pair of DC voltage outputs including a DC voltage positive output DC+ and a DC voltage negative output DC−. Each of the extension bulb holders 23 on the extension light string 2 is connected to the DC voltage outputs of the AC/DC converting unit 22 in parallel, and has a light emitting element 24 mounted therein.

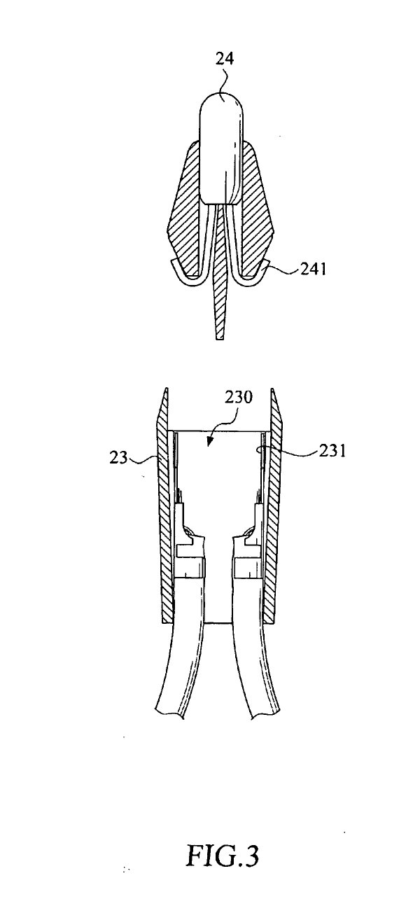

Please refer to FIG. 3 that is an exploded sectional view showing a light emitting element 24 separated from the extension bulb holder 23. As can be clearly seen from FIG. 3, the extension bulb holder 23 on the extension light string 2 defines an inner space 230 for receiving the light emitting element 24 therein. The inner space 230 is internally provided near an inner wall of the extension bulb holder 23 with two conductive strips 231 for electrically contacting with two conductive terminals 241 of the light emitting element 24.

In the present invention, the light emitting element 24 may be a bulb, a light-emitting diode (LED), or any other equivalent element that may be driven by AC or DC power to emit light; and the AC/DC converting unit 22 is a rectifier.

When the extension light string 2 is connected to the main light string 1 by plugging the connector 21 into an empty bulb holder 13, the conductive members 211 of the connector 21 lead the divided AC voltage at the empty bulb holder 13 to the AC/DC converting unit 22 of the extension light string 2, so that a DC voltage may be obtained at the DC voltage positive output DC+ and the DC voltage negative output DC−. The DC voltage will be naturally led to each of the extension bulb holders 23 parallelly connected to the DC voltage outputs for the light emitting elements 24 mounted in the extension bulb holders 23 to emit visible light.

The light emitting elements 24 on the extension light string 2 may include differently shaped covers to give the whole light string an enhanced decorating effect.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A light string with extension light string, comprising:
a main light string including:
an AC power plug for connecting to an AC power supply;
a light string wire circuit being connected to said AC power plug;
a plurality of bulb holders being connected to said light string wire circuit in series, such that each of said bulb holders is allocated a divided AC voltage of said AC power supply, and each of said bulb holders having a light emitting element mounted therein; and
at least one extension light string including:
a connector adapted to connect to an empty one of said bulb holders on said main light string that does not have a light emitting element mounted therein; said connector being provided with a pair conductive members for leading out said divided AC voltage from said empty bulb holder;
an AC/DC converting unit being connected to said connector for converting said divided AC voltage at said connector into a DC voltage, which is then output via a pair of DC voltage outputs; and
a plurality of extension bulb holders being parallelly connected to said DC voltage outputs of said AC/DC converting unit, and each of said extension bulb holders having a light emitting element mounted therein.

2. The light string with extension light string as claimed in claim 1, wherein said pair of DC voltage outputs includes a DC voltage positive output and a DC voltage negative output.

3. The light string with extension light string as claimed in claim 1, wherein said light emitting element is a light-emitting diode.

4. The light string with extension light string as claimed in claim 1, wherein said AC/DC converting unit is a rectifier.
